(19) United States
(12) Patent Application Publication
(10) Pub. No.: US 2012/0312016 A1
(43) Pub. Date: Dec. 13, 2012

(54) Geothermal Energy Method and Apparatus

(76) Inventor: Roland Lawes, Santigo (PA)

(21) Appl. No.: 13/340,889

(22) Filed: Dec. 30, 2011

Related U.S. Application Data
(60) Provisional application No. 61/520,469, filed on Jun. 13, 2011.

(51) Int. Cl. F03G 7/04

(52) U.S. Cl. 60/641.5

(57) ABSTRACT

A deep well geothermal system where the bottom pressure exceeds the critical pressure for a working fluid (for water, approximately 3200 psi) at a place where the well bottom temperature is above the critical temperature of the working fluid (for water approximately 374 degrees C.). For water, this depth would typically be around 7442 feet. Three concentric pipes make up the well. The outer pipe passes working fluid to the bottom of the well. It becomes super-heated vapor and is passed up though the inner pipe to a turbine. The middle pipe typically contains a vacuum and acts as an insulator around the inner pipe. The flow of vapor out of the turbine can be cooled and condensed and returned to the outer pipe to form a closed system.

This application claims priority from U.S. Provisional Patent application No. 61/520,469 filed Jun. 13, 2011.

### BACKGROUND

1. Field of the Invention

The present invention relates generally to the field of geothermal energy and more particularly to a geothermal energy method and apparatus that can use a deep well.

2. Description of the Prior Art

The world needs new and innovative sources of energy. Nuclear power plants use mined fuel, contain very dangerous materials, and have the potential to release radioactive materials into the environment. This was seen most recently in Japan. Wind, wave, solar, and hydraulic energy, on the other hand, all use a source of power that is available without direct cost and is generally environmentally friendly. However, such power sources do not produce a constant energy flow; they require some form of storage so that they can to be attuned to demand. Geothermal power extraction is typically friendly to the environment and also relatively constant.

Profitable geothermal plants, now operating, mostly fall into two types. One type gets hot water or steam at locations that have geyser like conditions where underground streams meet with high temperature strata to enable hot water or steam to be obtained through a drill pipe. In the case of the second type, there are no underground streams, so water is usually supplied to the strata by drilling a close-by second well. Both types are highly successful. One disadvantage is that the output typically is not pure steam. Other gasses also exit. Some of these are damaging to heat engines, and some pollute the atmosphere. Filters are usually required to remove or to react these gasses. Where the temperature difference is not great, the two pipes, in and out, can be encased in the same well.

An early geothermal well head is described by Reed in U.S. Pat. No. 4,342,363. Lobach in U.S. Pat. No. 3,908,380 describes a geothermal energy system with a turbine that uses super-heated steam.

It would be advantageous to have a geothermal system that uses a well deep enough to where the bottom pressure exceeds the critical pressure for water (or other working fluid).

### SUMMARY OF THE INVENTION

The present invention relates to a deep well geothermal system where the bottom pressure exceeds the critical pressure for a working fluid (for water, approximately 3200 psi) at a place where the well bottom temperature is above the critical temperature of the working fluid (for water approximately 374 degrees C.). For water, this depth would typically be around 7442 feet. Three concentric pipes make up the well. The outer pipe passes working fluid to the bottom of the well. It becomes super-heated vapor and is passed up though the inner pipe to a turbine. The middle pipe typically contains a vacuum and acts as an insulator around the inner pipe. The flow of vapor out of the turbine can be cooled and condensed and returned to the outer pipe to form a closed system.

### DESCRIPTION OF THE FIGURES

Several drawings are now presented to illustrate features of the present invention:

FIG. 1 shows a side schematic view of an embodiment of the invention.

FIG. 2 shows the relationship between flows in the various pipes.

Drawings and illustrations have been presented to aid in understanding the present invention. The scope of the present invention is not limited to what is shown in the figures.

### DESCRIPTION OF THE PREFERRED EMBODIMENT

The present invention relates to a deep-well geothermal system that is made up of three concentric pipes. The bottom of the well is located at a depth where both the temperature and pressure are above the critical values for water (or other working fluid). This is a pressure greater than or equal to approximately 3200 psi and a temperature greater than or equal to approximately 374 degrees C. This would be a depth of around 7442 feet. The lower end of the well might extend into molten lava. There are numerous locations that have these conditions. Such a well, while somewhat expensive to drill with current technology, is still cheaper per KWH of electricity than building a dam and reservoir.

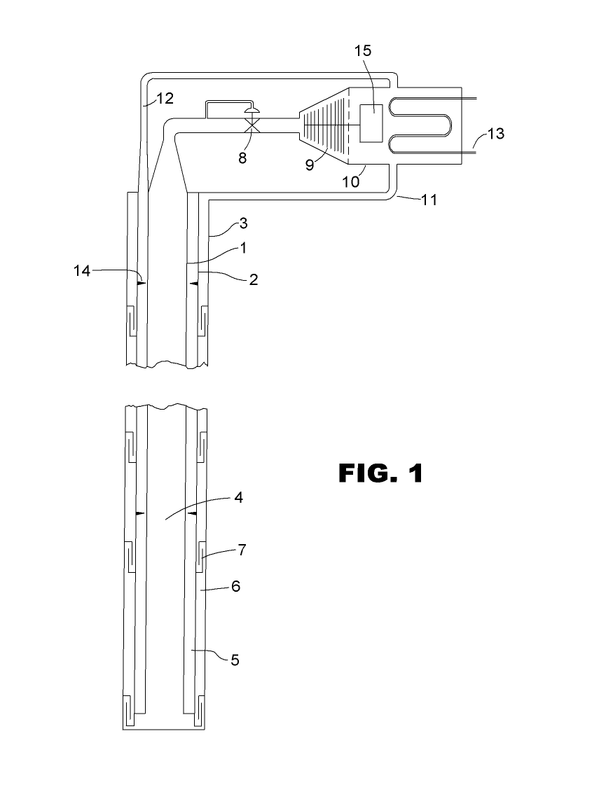

Turning to FIG. 1, and using water as a working fluid, an outer pipe 3 (for example of diameter 5 inches) passes water down to the bottom of the well. The exterior of the outer pipe 3 is typically uninsulated so that the water can heat on the way down. A middle pipe 2 (for example of diameter 4 inches) encloses a space under a vacuum and acts as an insulator for the inner pipe. The middle pipe can be condenser connected. The inner pipe 1 (for example of diameter 2½ inches) passes super-heated steam up and into a turbine 9 which can drive a generator 15. The interior region of the inner pipe 1 acts as a steam chamber 4. The interior of the middle pipe 2 acts as a vacuum chamber 5, and the interior of the outer pipe 3 acts as a water chamber 6. The outer pipe 3 contains numerous traps 7 that prevent steam from rising through the outer pipe. The inner 1 and middle 2 pipes typically only need to be connected at the bottom. Spines 14 in the middle pipe 2 can be provided to keep the inner pipe 1 centered while allowing a difference of longitudinal thermal expansion to take place between the inner pipe 1 and the middle pipe 2.

Super-heated steam from the inner pipe 1 is fed through a pressure regulator 8 and into a turbine 9, generator 15. Steam pressure at the well head can govern the amount of steam taken off to drive the load. Usually a turbine is used as a load to turn a generator to produce electricity; however, any other type use for the super-heated steam is within the scope of the present invention. Steam exiting the turbine 9 can be cooled and condensed in a condenser 10. The resulting water can be returned through a return line 11 to the outer pipe to complete a closed loop. Leakage, if any, must be made up. A water reservoir can be optionally used between the condenser and the return to the well. Since the system of the present invention is closed at the bottom, undesirable gasses cannot enter the system.

FIG. 1 shows a vacuum sustainer tube 12 from the condenser to the middle pipe 2. However, any method of sustaining the vacuum in the middle tube 2 is within the scope of the present invention. FIG. 1 also shows coolant piping 13 in the condenser. Any method of cooling the condenser is within the scope of the present invention.

While water is the preferred working fluid, any fluid can be used. In fact, the required well depth can be lessened by selecting a different working fluid. For example, diethyl ether has a critical pressure of 515 psi that would only require a well depth of around 1717 feet. Such a system would work at a much lower temperature as well. The choice of working fluid may be governed by possible well depth, handling difficulties, corrosion potential and the like.

Also, while the most advantageous use of the present invention occurs by boring to a depth that achieves critical pressure of the working fluid, the same three concentric pipes can be used for lower pressures and/or temperatures.

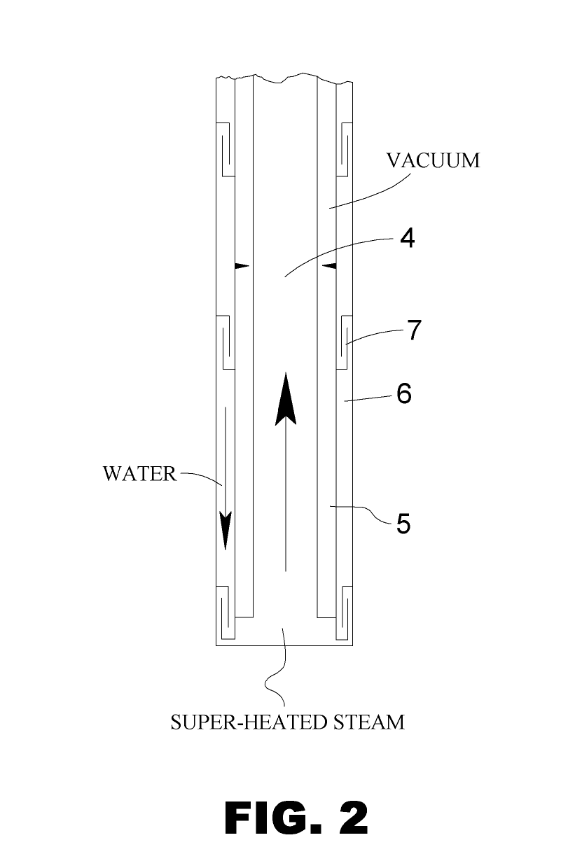

FIG. 2 shows the relative flows of steam, water and the location of the vacuum in a water system.

Several descriptions and illustrations have been presented to aid in understanding the present invention. One with skill in the art will realize that numerous changes and variations may be made without departing from the spirit of the invention. Each of these changes and variations is within the scope of the present invention.

I claim:

1. A method of capturing geothermal energy comprising:
providing a 3-pipe concentric pipe assembly having an inner, middle and outer pipe with a closed lower end with the outer and inner pipes being in fluid communication near said lower end, said assembly adapted to be placed in a geothermal well, wherein, at a well-bottom location, said geothermal well is deep enough to have a pressure exceeding critical pressure of a working fluid and a temperature exceeding critical temperature of the working fluid;
providing a source of said working fluid to the outer pipe;
providing a source of vacuum to the middle pipe;
removing a flow super-heated working fluid vapor from the inner pipe;
extracting energy at a top end of said well from said flow of super-heated working fluid vapor.

2. The method of claim 1 wherein said working fluid is water.

3. The method of claim 1 further comprising providing a plurality of gas traps in said outer pipe.

4. The method of claim 1 further comprising providing a plurality of spines in said middle pipe.

5. The method of claim 1 further comprising directing said flow of super-heated working fluid into a turbine.

6. The method of claim 5 further comprising directing an exhaust flow out of the turbine into a condenser.

7. The method of claim 6 further comprising returning working fluid from said condenser to said outer pipe.

8. A system for capturing geothermal energy comprising:
a 3-pipe concentric pipe assembly having an inner, middle and outer pipe with a closed lower end with the outer and inner pipes being in fluid communication near said lower end, said assembly adapted to be placed in a geothermal well;
said outer pipe adapted to direct a flow of working fluid downward into the well;
said middle pipe acting as an insulator between the inner and outer pipes;
said inner pipe adapted to direct a flow of super-heated working fluid vapor into an energy extractor.

9. The system of claim 8 wherein, at a well-bottom location, said geothermal well is deep enough to have a pressure exceeding critical pressure of the working fluid and a temperature exceeding critical pressure of the working fluid.

10. The system of claim 8 wherein, at a well-bottom location, said geothermal well has a pressure less than critical pressure of the working fluid.

11. The system of claim 8 wherein said working fluid is water.

12. The system of claim 8 wherein said outer pipe contains a plurality of gas traps.

13. The system of claim 8 further comprising providing a plurality of spines in said middle pipe.

14. The system of claim 8 further comprising a turbine fluidly connected to said inner pipe.

15. The system of claim 14 further comprising a condenser fluidly connected to an exhaust port of said turbine.

16. The system of claim 15 further comprising a return pipe wherein condensed fluid from said condenser is returned to said outer pipe.

17. A closed geothermal energy system comprising three concentric pipes closed at a bottom end that includes an inner pipe, a middle pipe, and an outer pipe, the outer pipe in fluid communication with the inner pipe at said bottom end, the concentric pipes adapted to be used in a geothermal well deep enough that bottom pressure exceeds or equals a critical pressure for water, and bottom temperature exceeds or equals a critical pressure for water, said outer pipe being in fluid communication at an upper end with a condenser such that water from said condenser enters the outer pipe and descends into the well heating while descending, and wherein near said bottom end, the water becomes super-heated steam which flows upward through the inner pipe and exits the inner pipe into a turbine in fluid communication with the inner pipe, wherein exhaust from said turbine flows into the condenser where it is condensed.

18. The system of claim 17 wherein said middle pipe is under a vacuum.

19. The system of claim 17 wherein said outer pipe contains a plurality of gas traps.

20. The system of claim 17 wherein said middle pipe contains a plurality of spines.
